(19) United States
(12) Patent Application Publication
(10) Pub. No.: US 2002/0066351 A1
(43) Pub. Date: Jun. 6, 2002

(54) Rotary cutter mounting member and rotary cutter fitted to the rotary cutter mounting member

(75) Inventors: Norio Sumida, Ebina-shi (JP); Shigeyoshi Kobayashi, Ebina-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SANKYO DIAMOND INDUSTRIAL CO., LTD., Ebina-shi (JP)

(21) Appl. No.: 09/996,741

(22) Filed: Nov. 30, 2001

(30) Foreign Application Priority Data
Dec. 5, 2000 (JP) 370050/2000

(51) Int. Cl. B26D 7/00

(52) U.S. Cl. 83/698.41; 83/835; 83/665; 30/388; 30/340

(57) ABSTRACT

There is provided a mounting member to be detachably screwed onto the rotary shaft of a power tool, and during the attachment and detachment of the mounting member to and from the power tool, a part for clamping and integrally securing a rotary cutter between an inner flange and an outer flange which functions as a lock nut is constructed by fitting a claw of the inner flange onto a fitting groove formed in the outer flange. Owing to this construction, it is possible to highly precisely and integrally secure the mounting member to individual rotary cutters.

### BACKGROUND OF THE INVENTION

1. Field of the Invention

The present invention relates to a mounting member for efficiently attaching and detaching a rotary cutter such as a diamond saw blade to and from the rotary shaft of a power tool or the like, as well as to a rotary cutter fitted to the mounting member. The rotary cutter has a mounting hole formed in the center portion of its circuit base plate so that the rotary cutter is mounted to the power tool, and an superabrasive grinding wheel portion essentially consisting of diamond abrasives or CBN abrasives is formed on the outer circumferential portion of the circuit base plate.

2. Background Art

Rotary cutters such as diamond saw blades or cup wheels are used in wide applications such as cutting and grinding of hard/fragile materials such as concrete or stone, ceramic materials such as tiles or roofing tiles, and work materials such as synthetic rubbers, synthetic resins and metals. Such a rotary cutter has a superabrasive grinding wheel portion which essentially consists of diamond abrasives or CBN abrasives and is formed on the outer circumferential portion of a circuit base plate which is normally made of steel, and a mounting hole for mounting the rotating cutter to a power tool or the like is provided in the central portion of the circular base plate. The rotary cutter is mounted to the power tool via a mounting jig attached to the power tool, and is used in various kinds of machining such as grinding and polishing by means of the rotational energy of the power tool.

Conventionally, the rotary cutter is mounted to the power tool in the way of fitting an inner flange 102 attached to the power tool onto a rotary shaft 101 of the power tool as shown in FIG. 8, then fitting the mounting hole of the rotary cutter 103 onto the rotary shaft 101, and then screwing the internal thread provided in the central portion of an outer flange 104 attached to the power tool, onto the external thread of the rotary shaft of the power tool, thereby clamping the rotary cutter 103 between the inner flange 102 and the outer flange 104.

In the above-described background art, the mounting of individual rotary cutters to the power tool is performed by using a flange member which is a mounting jig attached to the power tool, but no highly precise adjustments to the sizes of the individual rotary cutters are performed and a certain degree of allowable error is permitted to allow for wide applications. Owing to the allowable error, subtle center whirling occurs between the main shaft of the power tool and the mounting hole of the rotary cutter. Therefore, during substantial operation, a so-called tap phenomenon occurs in which the grinding-action surface of the rotary cutter does not smoothly contact the working portion of a work material and taps the working portion, and this tap phenomenon not only applies unpleasant vibrations to an operator, but also causes the problem that the life of the rotary cutter is reduced and the precision of working is impaired.

In the case where different work materials are to be used or a working operation is to be changed, the operator needs to replace a rotary cutter with an appropriate rotary cutter. However, at this time, since the operator repeats the manipulation of replacing the rotary cutter with another rotary cutter after removing the outer flange from the main shaft of the power tool, the operator needs to perform a time-consuming operation, so that there is a risk that the operator may lose a flange member. Accordingly, it is desirable that flange members are respectively fitted to individual rotary cutters, and some of commercially available rotary cutters have such a structure.

However, to achieve a structure which enables flange members to be respectively fitted to individual rotary cutters so that the rotary cutters can be highly precisely mounted to different kinds of power tools, the number of component parts must be increased in terms of design, so that an increase in cost cannot be avoided. Furthermore, the tool required to attach and detach the rotary cutter to and from the power tool is limited to a dedicated tool such as a pin face wrench attached to the power tool. If the dedicated tool is lost or the engaging hole of the outer flange with which to engage a wrench is damaged, attachment or detachment may become impossible.

### SUMMARY OF THE INVENTION

Therefore, the present invention provides at low cost a mounting member which is used for mounting a rotary cutter to a power tool or the like and which is provided integrally with each individual rotary cutter and can be easily and precisely attached to and detached from the power tool, as well as a rotary cutter fitted to such mounting member, the rotary cutter being represented by a diamond saw blade having a mounting hole in the central portion of its circuit base plate. The invention also provides a rotary cutter which can be easily attached or detached with not only a pin face wrench but also a general-purpose tool such as a monkey spanner because the shape of the flange part of an outer flange which functions as a lock nut during attachment and detachment to and from a power tool is designed to cope with plural kinds of tools.

The present invention which has been made to solve the above-described problem provides a rotary cutter mounting member to which is fitted a rotary cutter such as a diamond saw blade having a mounting hole in the center of its disk-shaped base plate and which can be detachably screwed onto the rotary shaft of a power tool. The rotary cutter includes an outer flange which functions as a lock nut when the rotary cutter mounting member is attached to and detached from the power tool, and an inner flange for clamping and integrally securing the rotary cutter between the outer flange and the inner flange. The outer flange is made of a flange part and a cylindrical part joined to the flange part, and an internal thread to be screwed onto an external thread of the rotary shaft of the power tool is formed on the bore surface of a central portion of the cylindrical part. A rotary cutter mounting portion onto which to fit the mounting hole of the rotary cutter is provided on the outer circumferential surface of the cylindrical part that is in contact with the back of the flange part, and a fitting groove is formed on the outer circumferential surface of the cylindrical part at a predetermined position closer to the front end of the cylindrical part. The inner flange is made of a flange front surface to be brought into abutment with the rotary cutter, and a flange back surface to be brought into abutment with the spindle of the power tool. The central portion of the inner flange has an inside-diameter surface provided with a first guide portion through which to insert the rotary shaft of the power tool, and a second guide portion into which to insert the outer circumferential surface of the cylindrical part of the outer flange. A claw to be fitted onto a fitting groove which is provided on the outer circumferential surface of the cylindrical part of the outer flange at a predetermined position closer to the front end of the cylindrical part is formed on the inner circumferential surface of a front end portion of the second guide portion. The fitting groove and the claw are fitted to each other while the rotary cutter fitted to the rotary cutter mounting portion of the outer flange is being pressed against the outer flange by the flange front surface of the inner flange, thereby integrally securing the outer flange, the rotary cutter and the inner flange to one another.

Furthermore, in the outer flange which constitutes the rotary cutter mounting member according to the present invention, the flange part which functions as the lock nut has a shape formed to correspond to a pin face wrench and a spanner, and an elastic-material accommodating space is provided at a predetermined position on the flange front surface of the inner flange which is to be brought into abutment with the rotary cutter, and the rotary cutter fitted to the rotary cutter mounting portion provided on the cylindrical part of the outer flange is fitted between the inner flange and the outer flange by being pressed against the outer flange by a resilient force due to an elastic material accommodated in the elastic-material accommodating space, thereby integrally securing the outer flange, the rotary cutter, and the inner flange to one another.

Incidentally, it is desirable that the fitting groove provided on the outer circumferential surface of the cylindrical part of the outer flange at the predetermined position closer to the front end of the cylindrical part be formed to have a width of 0.8 mm +α. The elastic material accommodated in the elastic-material accommodating space provided on the flange front surface of the inner flange is an elastic material selected from among a coned disc spring, a conical spring washer, a spring washer, a wave-form washer, a wave washer, a rosette washer and a lock washer having a spac and teeth.

In addition, a rotary cutter fitted to a mounting member according to the present invention is a rotary cutter such as a diamond saw blade. In the rotary cutter fitted to the rotary cutter mounting member having the above-described construction, the rotary cutter and the mounting member are formed integrally with each other.

### BRIEF DESCRIPTION OF THE DRAWINGS

The present invention will become more readily appreciated and understood from the following detailed description of preferred embodiments of the present invention when taken in conjunction with the accompanying drawings, in which:

FIG. 1 is a front view of an outer flange of an embodiment;

FIG. 2 is a cross-sectional view taken along line A-A of FIG. 1;

FIG. 3 is a front view of an inner flange of the embodiment; FIG. 4 is a cross-sectional view taken along line B-B of FIG. 3;

FIG. 5 is an assembly drawing of the embodiment;

FIG. 6 is a magnified cross-sectional view of the essential portions of the embodiment;

FIG. 7 is a magnified cross-sectional view of the essential portions of another embodiment; and

FIG. 8 is an explanatory view showing a background-art mounting structure.

### DETAILED DESCRIPTION

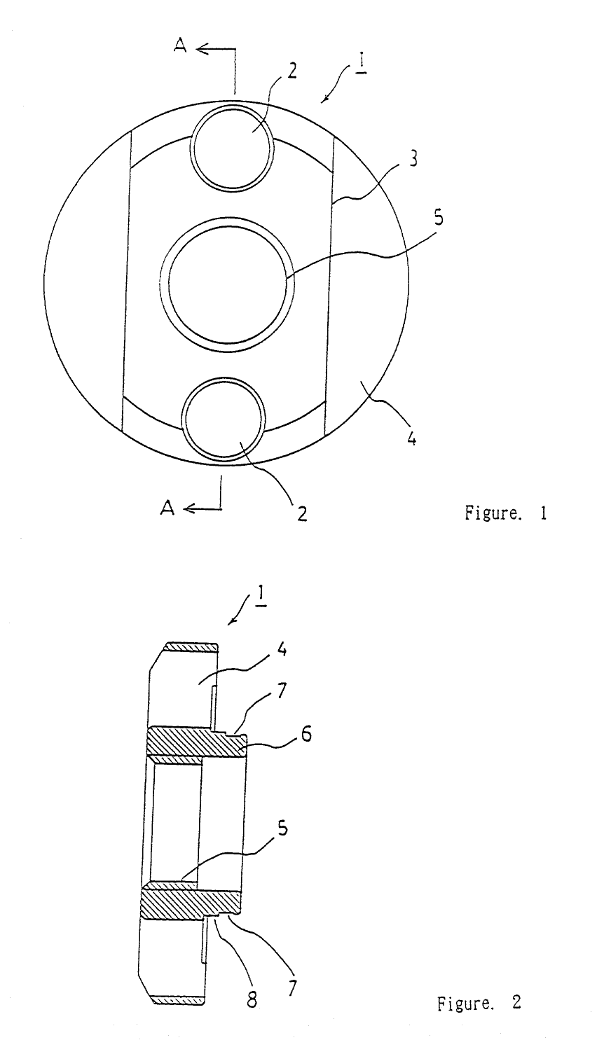

Preferred embodiments of the present invention will be described below with reference to FIGS. 1 to 6.

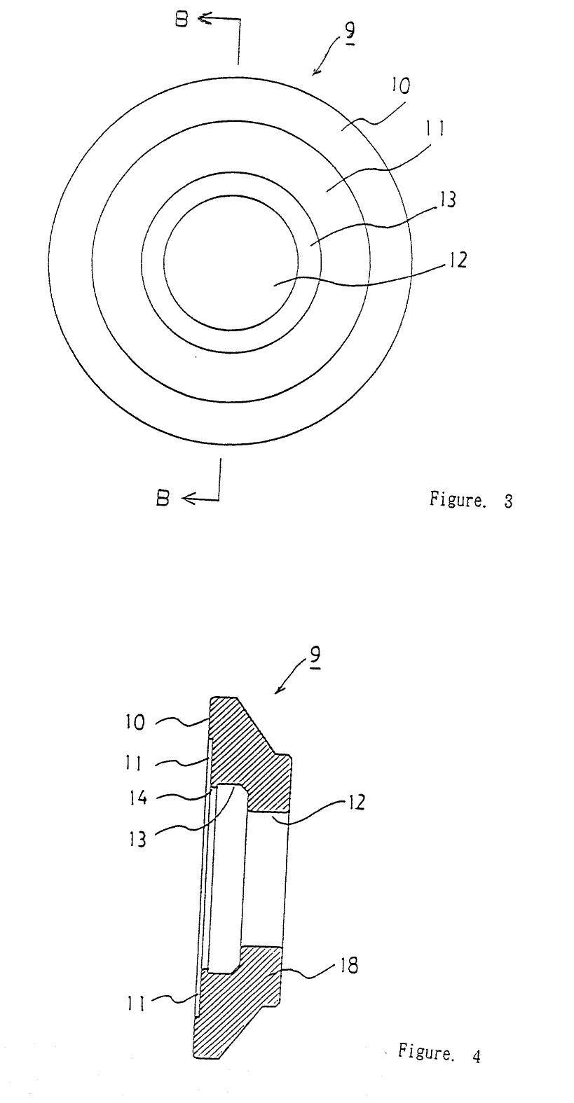

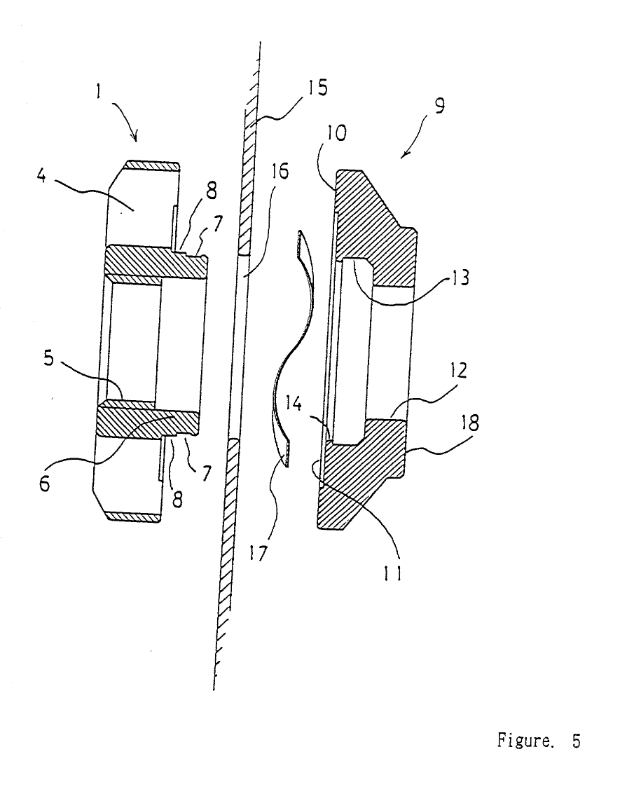

A rotary cutter mounting member according to one embodiment of the present invention basically includes an outer flange 1, which is shown in FIGS. 1 and 2, and an inner flange 9, which is shown in FIGS. 3 and 4. The outer flange 1 is made of a flange part 4 and a cylindrical part 6 joined to the back of the flange part 4, and an internal thread 5 to be screwed onto an external thread of the rotary shaft of a power tool (not shown) is formed on the bore surface of the central portion of the cylindrical part 6.

A spanner hook 3 and engaging holes 2 are formed in the front of the flange part 4 of the outer flange 1, whereby the flange part 4 can be attached and detached by means of not only a pin face wrench but a general-purpose medium size monkey spanner. Incidentally, the cylindrical part 6 is formed to be joined to the back of the flange part 4, and a rotary cutter mounting portion 8 is provided on the outer circumferential surface of the portion of the cylindrical part 6 that is in contact with the flange part 4, and a fitting groove 7 is formed on the outer circumferential surface of the cylindrical part 6 at a predetermined position closer to the front end of the cylindrical part 6. The groove 7 is provided to be fitted into a claw 14 which is formed on the inner circumferential surface of the front end portion of a second guide portion 13 of the inner flange 9 which will be described later. The depth of the groove 7 is normally approximately 0.5 mm, but is not particularly limited as long as the depth is in a range which makes it possible to achieve the purpose of firmly and integrally securing a rotary cutter 15 fitted to a rotary cutter mounting portion 8 in the state of being clamped between the inner flange 9 and the outer flange 1.

The width of the groove 7 is made 0.8 mm +α, and this tolerance enables the groove 7 to cope with a variation in the thickness of the base plate of the rotary cutter 15. In the case of a rotary cutter such as a diamond saw blade, the thickness of its steel-made base plate is normally determined by its outside diameter; for example, in the case of a diamond saw blade of outside diameter 100 mm, the thickness of its base plate is determined to be 0.8 to 1.2 mm, and in the case of a diamond saw blade of outside diameter 150 to 200 mm, the thickness of its base plate is determined to be approximately 1.2 to 1.8 mm. Accordingly, the groove 7 provided on the cylindrical part 6 of the outer flange 1 according to the present invention is formed to have a tolerance capable of coping with the thicknesses of such base plates.

The inner flange 9 shown in FIGS. 3 and 4 serves the role of clamping and integrally securing the rotary cutter 15 fitted on the rotary cutter mounting portion 8 of the outer flange 1 and adjusting the distance between the rotary cutter 15 and the notched portion of the spindle of a power tool, and has a function corresponding to a combination of an inner flange and an adapter (washer) which have heretofore been used as accessory parts of a power tool.

The specific construction of the inner flange 9 includes a flange front surface 10 to be brought into abutment with the rotary cutter 15, and a flange back surface 18 to be brought into abutment with the spindle (not shown in any of the accompanying drawings) of the power tool, and the inner circumferential surface of the inner flange 9 has a ring-shaped appearance which is formed by a first guide portion 12 through which to insert the rotary shaft (not shown in any of the accompanying drawings) of the power tool, and a second guide portion 13 into which to insert the cylindrical part 6 of the outer flange 1.

An elastic-material accommodating space 11 to accommodate an elastic-material 17 is formed on the flange front surface 10 of the inner flange 9, and the claw 14 having a protruding shape is formed on the inner circumferential surface of the front end portion of the second guide portion 13. The claw 14 is fitted onto the fitting groove 7 which is provided on the outer circumferential surface of the cylindrical part 6 of the outer flange 1 at the position closer to the front end of the cylindrical part 6, whereby the claw 14 functions to cause the rotary cutter 15 to be clamped and integrally secured between the outer flange 1 and the inner flange 9.

An elastic material 17 is accommodated, as required, in the elastic-material accommodating space 11 provided on the flange front surface 10 of the inner flange 9. The shape of the elastic-material accommodating space 11 is not particularly limited in terms of inside diameter, depth, size or volume, and may be an arbitrary shape that enables the elastic material 17 to fully function its resilient force.

Incidentally, in the case where the thickness of the base plate of the rotary cutter 15 is small and sufficient pressing force for the rotary cutter 15 cannot be obtained only by fitting, the elastic material 17 accommodated in the elastic-material accommodating space 11 provided in the inner flange 9 serves the function of firmly and integrally securing the rotary cutter 15 by fitting, by means of its resilient force, the claw 14 formed on the inner circumferential surface of the front end portion of the second guide portion 13 of the inner flange 9, onto the fitting groove 7 provided in the cylindrical part 6 of the outer flange 1, while pressing the rotary cutter 15 fitted to the rotary cutter mounting portion 8 of the outer flange 1 against the back of the flange part 4 of the outer flange 1.

The outer flange 1 and the inner flange 9 used in the present invention are fabricated from a commercially available tool steel material by cutting with a lathe. For the purpose of preventing center whirling and side runout, it is desirable that the degree of parallelism between the flange front surface 10 of the inner flange 9 to be brought into abutment with the base plate of the rotary cutter 15 and the flange back surface 18 be made 1/100 or less and various other sliding surfaces be also finished with high precision. Incidentally, since the rotary cutter 15 according to the present invention is integrally secured to the rotary cutter mounting member which includes the outer flange 1 and the inner flange 9 in the above-described manner, it is guaranteed that the center of the internal thread 5 of the outer flange 1 and the rotary cutter 15 fitted to the rotary cutter mounting portion 8 provided on the cylindrical part 6 of the outer flange 1 can operate coaxially. Accordingly, center whirling is prevented from being caused by allowable error due to a flange member attached to a power tool which has heretofore generally been used, and it is possible to effectively reduce an unpleasant tap phenomenon.

The rotary cutter 15 fitted to the rotary cutter mounting member according to the present invention is a rotary cutter such as a diamond saw blade having a mounting hole 16 in the center of its disk-shaped base plate, and the rotary cutter 15 is integrally fitted with a mounting member to be detachably screwed onto the rotary shaft of a power tool or the like. The mounting member includes the outer flange 1 which functions as a lock nut when the mounting member is attached to and detached from a power tool, and the inner flange 9 for clamping and integrally securing the rotary cutter 15 between the outer flange 1 and the inner flange 9. The rotary cutter 15 fitted to the rotary cutter mounting portion 8 provided on the cylindrical part 6 of the outer flange 1 is fitted between the outer flange 1 and the inner flange 9 by being pressed against the back of the flange part 4 of the outer flange 1 by the flange front surface 10 of the inner flange 9 or by the resilient force of the elastic material 17 accommodated in the elastic-material accommodating space 11 provided on the flange front surface 10, whereby the outer flange 1, the rotary cutter 15 and the inner flange 9 are integrally secured to one another to integrally form the rotary cutter 15 and the mounting member.

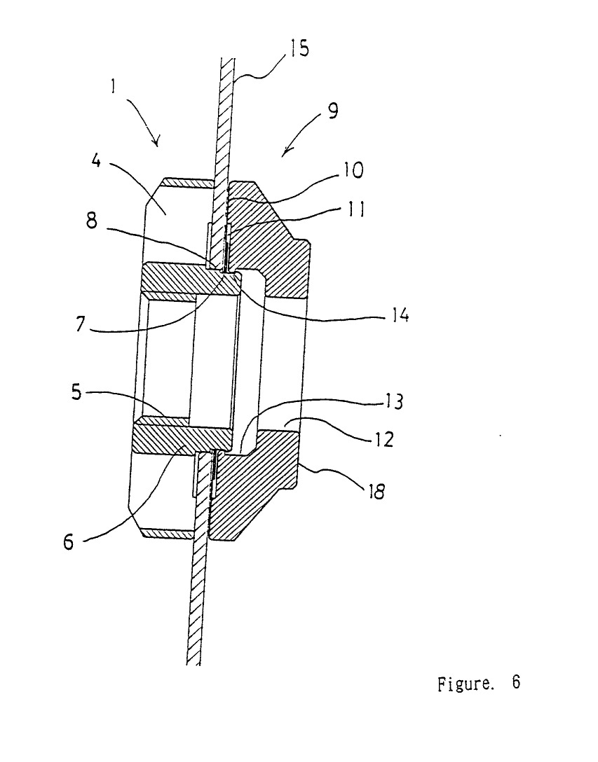

Specifically, as is apparent from the assembly drawing shown in FIG. 5 as well as a magnified view of the essential portions placed in the assembled state shown in FIG. 6, the rotary cutter fitted to the rotary current mounting member according to the present invention is provided by fitting the claw 14 formed on the inner circumferential surface of the front end portion of the second guide portion 13 of the inner flange 9, onto the fitting groove 7 provided in the outer circumferential surface of the cylindrical part 6 of the outer flange 1 at the position closer to the front end of the cylindrical part 6, while pressing the rotary cutter 15 fitted to the rotary cutter mounting portion 8 provided on the cylindrical part 6 joined to the back of the flange part 4 of the outer flange 1, against the outer flange 1 by the flange front surface 10 of the inner flange 9 or by the elastic material 17 accommodated in the elastic-material accommodating space 11 provided on the flange front surface 10, thereby firmly and integrally forming the outer flange 1, the rotary cutter 15 and the inner flange 9 with high precision. Incidentally, it is also possible to select, as long as cost permits, the processing of more beautifully finishing the rotary cutter mounting member according to the present invention and ensuring its surface hardness to prevent the occurrence of rust and flaws, by plating or the like.

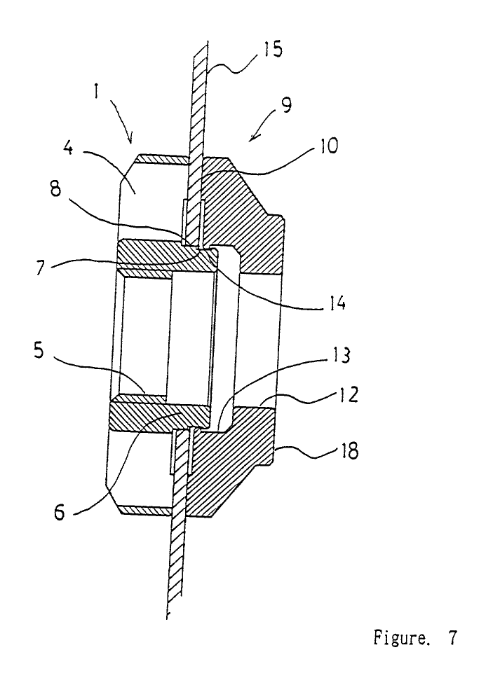

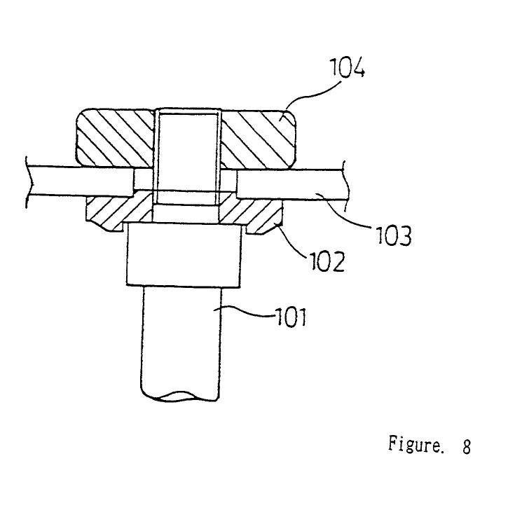

FIG. 7 is a magnified cross-sectional view of the essential portions of a rotary cutter fitted to a rotary cutter mounting member which does not need an elastic member in the present invention. In FIG. 7, the same reference numerals are used to denote the same constituent elements as those shown in FIG. 6, and the description of the same constituent elements is omitted. The mounting member shown in FIG. 7 differs from that shown in FIG. 6 in that an elastic member is not used, and even the mounting member having the construction shown in FIG. 7 can serve the same advantage as that of the embodiment of the present invention described above with reference to FIG. 6.

The rotary cutter fitted to the mounting member according to the present invention is a diamond tool which is represented by a diamond saw blade in which an superabrasive grinding wheel portion essentially consisting of diamond abrasives or CBN abrasives is formed on the outer circumferential portion of a steel-made base plate which normally has a circular shape. The rotary cutter is used in wide applications such as cutting, grinding and polishing of hard/fragile materials represented by concrete or stone, ceramic materials such as tiles or roofing tiles, synthetic rubbers, synthetic resins, metals and building materials. In general, the rotary cutter is fitted to the rotary shaft of a handy type of power tool via the mounting member, and is used in various kinds of machining by means of the rotational energy of the power tool.

One of the embodiments of the present invention will be described below far more specifically with reference to the accompanying drawings. In the embodiment which will be described below, a 5-inch segment type of diamond saw blade having a base plate of thickness 1.2 mm is selected as the rotary cutter. However, the present invention is not limited to only this construction, and may be adequately modified within the scope of the present invention.

FIG. 1 shows the front of the outer flange 1 of the embodiment, and FIG. 2 is a cross-sectional view of the outer flange 1. In the embodiment, a tool steel material of S45C is used as a material and the outer flange 1 is fabricated by cutting the material with a lathe. The flange part 4 of the outer flange 1 is formed to have an outside diameter of 43 mm and a thickness of 8 mm, and the cylindrical part 6 is formed to have an outside diameter of 22 mm and a thickness of 3.9 mm and was joined to the back of the flange part 4. The engaging holes 2 for a pin face wrench are formed in the surface of the flange part 4, and in addition, a notched portion of width 24 mm and depth 5 mm is formed as the spanner hook 3. This construction makes it possible to select a spanner (a monkey spanner) in addition to a pin face wrench when the flange part 4 is to be attached to and detached from a power tool.

The rotary cutter mounting portion 8 of outside diameter 22 mm and width 1.3 mm onto which to fit the mounting hole 16 of the rotary cutter 15 is formed on the outer circumferential surface of the portion of the cylindrical part 6 which is in contact with the back of the flange part 4 of the outer flange 1 which is to be connected to a power tool. The rotary cutter mounting portion 8 is machined with high precision according to the inside diameter of the mounting hole 16 formed in the center of the rotary cutter 15.

The fitting groove 7 is formed on the outer circumferential surface of the cylindrical part 6 at the position connected to the rotary cutter mounting portion 8 and closer to the front end of the cylindrical part 6. The groove 7 is formed with a depth of 0.5 mm deep and a width of 1.8 mm on the outer circumferential surface at a position 0.8 mm inward from the front end of the cylindrical part 6. The width of 1.8 mm provided in the groove 7 is the so-called tolerance required to cope with the thickness of the base plate of the rotary cutter 15 to be used.

An internal thread to be screwed onto the external thread of the rotary shaft of a power tool is formed in the central portion of the outer flange 1. In the embodiment, the internal thread is formed as a metric thread of pitch 2 mm and inside diameter 16 mm to cope with a power tool such as a general-purpose handy type of grinder.

The inner flange 9 in the embodiment is used to clamp and integrally secure the rotary cutter 15 fitted to the rotary cutter mounting portion 8 of the outer flange 1, but also serves the role of adjusting the distance between the rotary cutter 15 and the notched portion of the spindle of a power tool, thereby providing a function corresponding to a combination of an inner flange and an adapter (washer or ring) which have heretofore been used as accessory parts of a power tool.

FIG. 3 is a front view of the inner flange 9 of the embodiment, and FIG. 4 is a cross-sectional view of the inner flange 9. The inner flange 9 has a maximum outside diameter of 43 mm and a total thickness of 10 mm, and the inner circumferential surface of the inner flange 9 has a ring-like shape which is formed by the first guide portion 12 of inside diameter 16 mm and length 5 mm through which to insert the rotary shaft of a power tool, and the second guide portion 13 of inside diameter 22.4 mm and depth 5 mm into which to insert the cylindrical part 6 of the outer flange 1.

The claw 14 is formed to extend around the inner circumferential surface of the front end portion of the second guide portion 13 of the inner flange 9, and the claw 14 has a protruding shape having a width of 0.8 mm and a protrusion height of 0.2 mm from the inner circumferential surface. The claw 14 is fitted onto the fitting groove 7 provided in the cylindrical part 6 of the outer flange 1, and functions to clamp and integrally secure the rotary cutter 15 between the outer flange 1 and the inner flange 9.

A recess into which to accommodate the elastic material 17, i.e., the elastic-material accommodating space 11, is formed on the flange front surface 10 of the inner flange 9 that is to be brought into abutment with the rotary cutter 15 when the rotary cutter 15 is fitted. Since the wave washer shown in FIG. 5 is used as the elastic material 17, the elastic-material accommodating space 11 in the embodiment is formed to have an inside diameter of 33 mm (the outside diameter of the elastic-material accommodating space 11) and a depth of 0.5 mm according to the size of the wave washer used. Incidentally, FIG. 5 shows a part of the elastic material (wave washer) 17.

During lathing, the outer flange 1 and the inner flange 9 in the embodiment are finished while careful attention is being paid to the sliding surfaces and the degree of parallelism, in order to achieve one object of the present invention, i.e., for the purpose of preventing center whirling and side runout of the rotary cutter 15, particularly so that the degree of parallelism between the flange back surface 18 of the inner flange 9 to be brought into abutment with the notched portion of the spindle of a power tool and the flange front surface 10 to be brought into abutment with the base plate of the rotary cutter 15 can reach 1/100 or less.

The rotary cutter 15 fitted to the mounting member of the embodiment is shown as a 5-inch segment type of diamond saw blade by way of example. As is apparent from the assembly drawing shown in FIG. 5 as well as the magnified view of the essential portions shown in FIG. 6, the rotary cutter 15 is fitted by fitting the mounting hole 16 of the rotary cutter 15 onto the rotary cutter mounting portion 8 provided on the cylindrical part 6 of the outer flange 1, then fitting the second guide portion 13 of the inner flange 9 onto the cylindrical part 6 of the outer flange 1 while pressing the rotary cutter 15 by means of the elastic material (wave washer) 17 loaded in the elastic-material accommodating space 11 of the inner flange 9, and then fitting the claw 14 provided on the front end portion of the second guide portion 13, onto the groove 7 provided on the cylindrical part 6. Then, the mounting member to which the rotary cutter 15 is fitted is screwed onto the rotary shaft of a power tool, and subsequently, when the rotary shaft rotates, the outer flange 1 receives a force which acts in the fastening direction, while the inner flange 9 comes into abutment with the spindle of the power tool and the movement of the inner flange 9 is restricted. Thus, the outer flange 1, the rotary cutter 15 and the inner flange 9 are far more firmly secured to one another. Incidentally, FIGS. 5 and 6 show a partial cross section of the rotary cutter 15 with a superabrasive grinding wheel portion being omitted from the outer circumferential surface of the circular base plate of the rotary cutter 15.

According to the embodiment obtained in the above-described manner, in the diamond saw blade fitted to the mounting member, the mounting member is constructed as an element of the rotary cutter so that it can be readily attached to and detached from the power tool. In addition, it has been confirmed that since the rotary cutter is fitted to the mounting member with extremely high precision, center whirling and side runout are effectively reduced when the rotary cutter is subjected to substantial grinding. On the other hand, since the mounting member is firmly secured to the rotary cutter in the embodiment, it is possible to prevent an unexpected accident which occurs when an operator intentionally detaches the mounting member from the rotary cutter and uses it for other purposes.

The rotary cutter mounting member according to the present invention can use a commercially available tool steel material which is easy to obtain, and can be easily machined owing to its simple design and can be inexpensively provided because of a reduced number of component parts. In addition, since the mounting member is highly precisely and firmly secured to individual rotary cutters, rotary cutters can be easily replaced during substantial operation. Accordingly, center whirling and side runout are prevented from being caused by allowable error due to a mounting member attached to a conventional power tool, and an unpleasant tap phenomenon due to the allowable error is prevented, whereby the life performance of the rotary cutter can be improved and excellent precision machining is enabled.

What is claimed is:

1. A rotary cutter mounting member to which is fitted a rotary cutter such as a diamond saw blade having a mounting hole in the center of its disk-shaped base plate and which can be detachably screwed onto the rotary shaft of a power tool, comprising:
an outer flange which functions as a lock nut when the rotary cutter mounting member is attached to and detached from the power tool; and
an inner flange for clamping and integrally securing the rotary cutter between the outer flange and the inner flange,
the outer flange being made of a flange part and a cylindrical part joined to the flange part, an internal thread to be screwed onto an external thread of the rotary shaft of the power tool being formed on the bore surface of a central portion of the cylindrical part, a rotary cutter mounting portion onto which to fit the mounting hole of the rotary cutter being provided on the outer circumferential surface of the cylindrical part that is in contact with the back of the flange part, a fitting groove being formed on the outer circumferential surface of the cylindrical part at a predetermined position closer to the front end of the cylindrical part,
the inner flange being made of a flange front surface to be brought into abutment with the rotary cutter, and a flange back surface to be brought into abutment with the spindle of the power tool, the central portion of the inner flange having an inside-diameter surface provided with a first guide portion through which to insert the rotary shaft of the power tool, and a second guide portion into which to insert the outer circumferential surface of the cylindrical part of the outer flange, a claw to be fitted onto a fitting groove which is provided on the outer circumferential surface of the cylindrical part of the outer flange at a predetermined position closer to the front end of the cylindrical part being formed on the inner circumferential surface of a front end portion of the second guide portion,
the fitting groove and the claw being fitted to each other while the rotary cutter fitted to the rotary cutter mounting portion of the outer flange is being pressed against the outer flange by the flange front surface of the inner flange, thereby integrally securing the outer flange, the rotary cutter and the inner flange to one another.

2. A rotary cutter mounting member according to claim 1, wherein the outer flange which constitutes the rotary cutter mounting member and functions as the lock nut has a shape formed to correspond to a pin face wrench and a spanner, an elastic-material accommodating space being provided at a predetermined position on the flange front surface of the inner flange which is to be brought into abutment with the rotary cutter, the rotary cutter fitted to the rotary cutter mounting portion provided on the cylindrical part of the outer flange being fitted between the inner flange and the outer flange by being pressed against the outer flange by a resilient force due to an elastic material accommodated in the elastic-material accommodating space, thereby integrally securing the outer flange, the rotary cutter, and the inner flange to one another.

3. A rotary cutter mounting member according to claim 1, wherein the fitting groove provided on the outer circumferential surface of the cylindrical part of the outer flange at the predetermined position closer to the front end of the cylindrical part is formed to have a width of 0.8 mm+α.

4. A rotary cutter mounting member according to claim 2, wherein the elastic material is an elastic material selected from among a coned disc spring, a conical spring washer, a spring washer, a wave-form washer, a wave washer, a rosette washer and a lock washer having a spac and teeth.

5. A rotary cutter fitted to a mounting member, wherein the mounting member is the rotary cutter mounting member according to claim 1.
